(19) United States
(12) Patent Application Publication
(10) Pub. No.: US 2010/0199112 A1
(43) Pub. Date: Aug. 5, 2010

(54) INFORMATION PROCESSING APPARATUS AND POWER SUPPLY CONTROL METHOD

(75) Inventors: Ryuhei Yokota, Tokyo (JP); Takayuki Ochiai, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/625,454

(22) Filed: Nov. 24, 2009

(30) Foreign Application Priority Data
Jan. 30, 2009 (JP) 2009-020380

(51) Int. Cl. G06F 1/26

(52) U.S. Cl. 713/300

(57) ABSTRACT

According to one embodiment, an information processing apparatus includes a plurality of interface ports, a device detector, and a power supply controller. The interface ports are configured to be supplied with power from the information processing apparatus and connected to a plurality of external devices. The device detector is configured to detect whether one of the external devices is connected to one of the interface ports. The power supply controller is configured to control whether to supply power to the one of the external devices connected to the one of the interface ports detected by the device detector based on power tolerance of the information processing apparatus, a total amount of power of external devices in use, and a power capacity of the one of the external devices.

### CROSS-REFERENCE TO RELATED APPLICATIONS

This application is based upon and claims the benefit of priority from Japanese Patent Application No. 2009-020380, filed Jan. 30, 2009, the entire contents of which are incorporated herein by reference.

### BACKGROUND

1. Field

One embodiment of the invention relates to an information processing apparatus provided with a plurality of interface ports that supply power to an external device connected thereto and a power supply control method.

2. Description of the Related Art

An information processing apparatus such as a personal computer (PC) is generally provided with various interfaces for connection to external devices (peripheral devices) to extend functions. Among such interfaces is one that supplies power from the PC system to an external device connected via a port thereto as well as communicating signals related to data with the external device. Examples of this type of interfaces include a universal serial bus (USB) interface, an IEEE1394 interface, a PS/2 bus, and the like.

To control power supply to a plurality of external devices connected to the PC system via the interfaces as described above, there has been proposed a conventional technology in which, when the sum of currents consumed by external devices exceeds a predetermined value, power supply to them is terminated (see Japanese Patent Application Publication (KOKAI) No. 2003-216287).

There has also been proposed a conventional technology in which, when a storage medium that consumes more current than expected is connected to a storage device, power is not to be supplied to the storage medium (see Japanese Patent Application Publication (KOKAI) No. 2004-29893).

In recent years, to externally connect a serial advanced technology attachment (SATA) device to a PC system, notebook PC products with an external SATA (eSATA) interface (port) have been developed and reasonably available in the commercial marketplace. According to the current eSATA standard, as illustrated in FIG. 14, only Tx, Rx, and GND are connected to a PC system, and an eSATA device is supplied with power from the outside of the PC system.

In view of this, eSATA power (eSATAp), i.e., an extended standard of eSATA, is under development. As illustrated in FIG. 15, the eSATAp standard is expected to enable power supply from the PC system.

The conventional PC system, as with the eSATAp standard, is provided with an interface to supply power therefrom. As an example of such an interface may be cited a USB interface port. With power supplied from the PC system through the USB interface port, a USB device that supports bus-powered mode can operate. Some recent external USB devices and eSATA devices require large power and consume, for example, 2.5 A. As illustrated in FIG. 16, if the PC system becomes to support an eSATAp device in the future in addition to external USB devices, it is concerned that the entire PC system runs short of power to be supplied.

To cope with such a situation, the power capacity of the PC system may be simply increased. This, however, may cause an increase in cost and alternating current (AC) adaptor capacity, and upsize the PC system, resulting in inconvenience for the user.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of an information processing apparatus according to an embodiment of the invention;

FIG. 2 is an exemplary block diagram of a system configuration of the information processing apparatus illustrated in FIG. 1;

FIG. 3 is an exemplary circuit diagram of a device detection circuit for detecting an external device connected to each port of the information processing apparatus illustrated in FIG. 1;

FIG. 4 is an exemplary circuit diagram of a power supply control circuit that determines the amount of power used by an external device connected to each port of the information processing apparatus illustrated in FIG. 1 and controls power supply to the port;

FIG. 5 is an exemplary circuit diagram of a circuit equivalent to the output part of the device detection circuit illustrated in FIG. 4;

FIG. 6 is an exemplary schematic diagram for explaining the relationship between a threshold of voltage based on the system current tolerance and an intermediate potential input to a power controller when at least one device is connected to the port;

FIG. 7 is another exemplary schematic diagram for explaining the relationship between a threshold of voltage based on the system current tolerance and an intermediate potential input to the power controller when at least one device is connected to the port;

FIG. 8 is an exemplary flowchart of the operation of the information processing apparatus illustrated in FIG. 1 related to power supply control;

FIG. 9 is an exemplary schematic diagram of a screen indicating, when an external device is to be connected to an unused port of the information processing apparatus illustrated in FIG. 1, that the unused port is not available;

FIG. 10 is an exemplary schematic diagram of a screen indicating the status of each port of the information processing apparatus illustrated in FIG. 1;

FIG. 11 is an exemplary schematic diagram of a screen displayed to select a port (an external device) used in the information processing apparatus illustrated in FIG. 1;

FIG. 12 is another exemplary circuit diagram of a device detection circuit for detecting an external device connected to each port of the information processing apparatus illustrated in FIG. 1;

FIG. 13 is another exemplary circuit diagram of a power supply control circuit that determines the amount of power used by an external device connected to each port of the information processing apparatus illustrated in FIG. 1 and controls power supply to the port;

FIG. 14 is an exemplary schematic diagram for explaining communication between an information processing apparatus and an external device compatible with the eSATA standard;

FIG. 15 is an exemplary schematic diagram for explaining communication between an information processing apparatus and an external device compatible with the eSATAp standard; and

FIG. 16 is an exemplary schematic diagram for explaining power supply between an information processing apparatus and a plurality of external devices.

### DETAILED DESCRIPTION

Various embodiments according to the invention will be described hereinafter with reference to the accompanying drawings. In general, according to one embodiment of the invention, an information processing apparatus comprises a plurality of interface ports, a device detector, and a power supply controller. The interface ports are configured to be supplied with power from the information processing apparatus and connected to a plurality of external devices. The device detector is configured to detect whether one of the external devices is connected to one of the interface ports. The power supply controller is configured to control whether to supply power to the one of the external devices connected to the one of the interface ports detected by the device detector based on power tolerance of the information processing apparatus, a total amount of power of external devices in use, and a power capacity of the one of the external devices.

According to another embodiment of the invention, there is provided a power supply control method applied to an information processing apparatus comprising a plurality of interface ports configured to be connected to a plurality of external devices, a device detector, and a power supply controller for the interface ports from the information processing apparatus. The power supply control method comprises: detecting whether one of the external devices is connected to one of the interface ports; and controlling whether to supply power to the one of the external devices connected to the one of the interface ports detected by the device detector based on power tolerance of the information processing apparatus, a total amount of power of external devices in use, and a power capacity of one of the external devices.

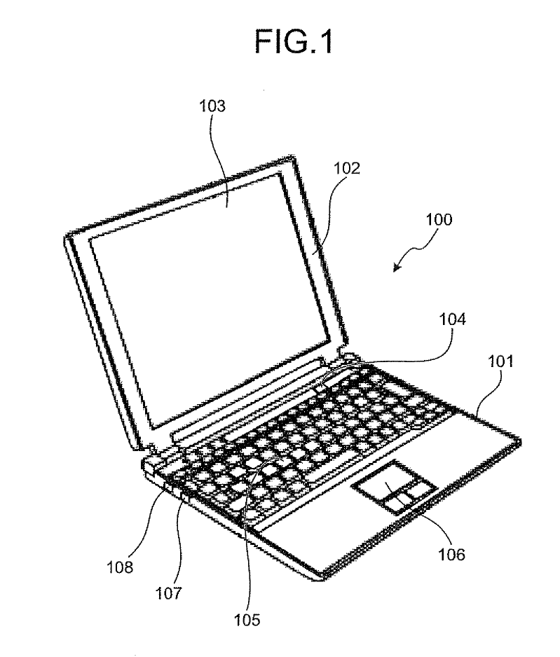

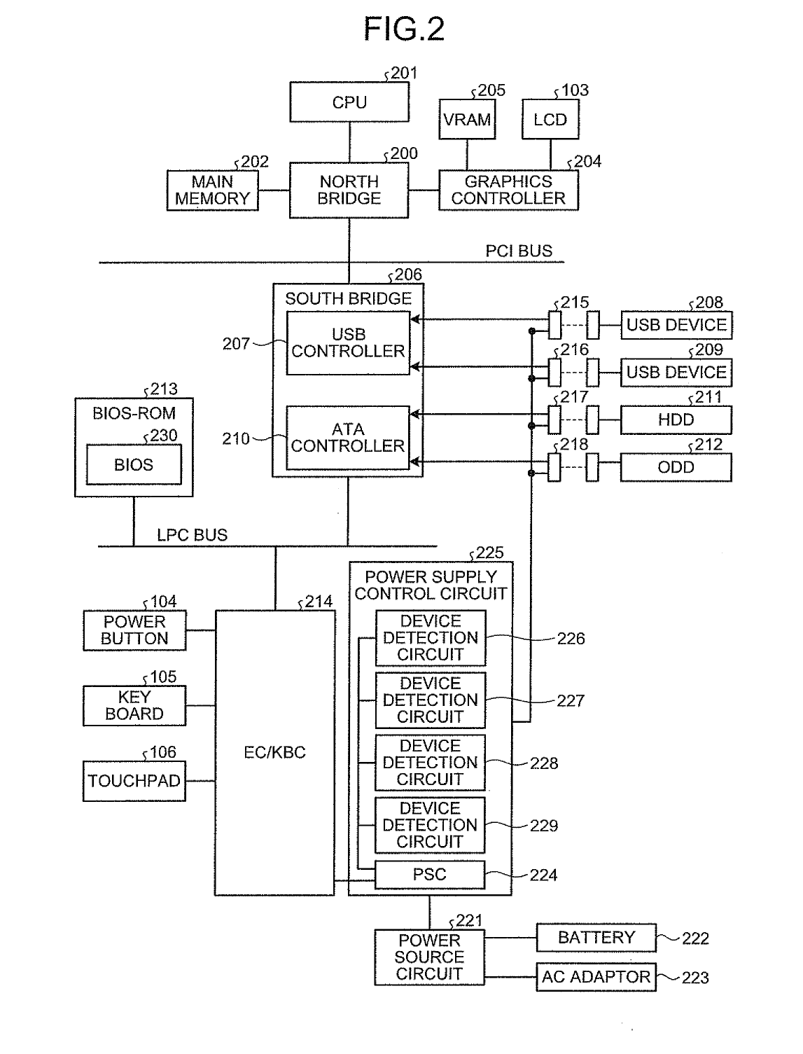

With reference to FIGS. 1 and 2, a description will now be given of a configuration of an information processing apparatus according to an embodiment of the invention. The information processing apparatus will be described by way of example as a notebook personal computer (PC) 100 that can be driven by a battery.

FIG. 1 is a perspective view of the PC 100 according to the embodiment. The PC 100 comprises a main body unit 101 and a display unit 102. FIG. 1 illustrates the PC 100 with the display unit 102 in an open position. The display unit 102 comprises a display device including a liquid crystal display (LCD) 103. The display screen of the LCD 103 is located at substantially the center of the display unit 102.

The display unit 102 is supported on the main body unit 101 so that the display unit 102 can freely rotate between closed and open positions. The display unit 102 covers over the upper surface of the main body unit 101 in the closed position, while it exposes the upper surface in the open position. The main body unit 101 has a housing formed in a flat box shape. On the upper surface of the main body unit 101 are arranged a power button 104, a keyboard 105, a touchpad 106, and the like.

The main body unit 101 is provided with two connection ports 107 and 108 on, for example, the left side surface. Various types of devices can be removably connected to the connection ports 107 and 108. The connection ports 107 and 108 are formed of, for example, connectors compatible with the universal serial bus (USB) standard. For example, a device compatible with the USB standard (a USB device), a device compatible with the eSATAp standard (an eSATAp device), or the like can be connected as required to each of the connection ports 107 and 108.

FIG. 2 is a block diagram of a system configuration of the PC 100.

As illustrated in FIG. 2, the PC 100 comprises the LCD 103, the power button 104, the keyboard 105, the touchpad 106, a central processing unit (CPU) 201, a main memory 202, a north bridge 203, a graphics controller 204, a video random access memory (VRAM) 205, a south bridge 206, a USB controller 207, USB devices 208 and 209, an advanced technology attachment (ATA) controller 210, a hard disk drive (HDD) 211, an optical disk drive (ODD) 212, a basic input/output system-read only memory (BIOS-ROM) 213, an embedded controller/keyboard controller (EC/KBC) 214, a power supply circuit 221, a battery 222, an alternating current (AC) adaptor 223, a power source controller (PSC) 224, a power supply control circuit 225, and device detection circuits 226 to 229.

The CPU 201 controls the overall operation of the PC 100. The CPU 201 executes an operating system (OS) and various application programs loaded into the main memory 202. The OS and the application programs are stored in a magnetic disk storage medium (a hard disk) mounted on the HDD 211, an optical disk storage medium mounted on the ODD 212, and the like, and loaded into the main memory 202 therefrom.

The CPU 201 also executes a BIOS program (hereinafter, “BIOS”) 230 stored in the BIOS-ROM 213. The BIOS-ROM 213 is a nonvolatile memory such as a flash electrically erasable programmable read only memory (EEPROM) so that it can be rewritten with a program.

The BIOS 230 is a program for controlling various types of hardware components of the PC 100. The BIOS 230 is read from the BIOS-ROM 213 when the PC 100 is activated.

The north bridge 203 connects between a local bus of the CPU 201 and the south bridge 206. The north bridge 203 comprises a memory controller that controls access to the main memory 202. The north bridge 203 has the function of communicating with the graphics controller 204 through an accelerated graphics port (AGP) bus or the like.

The graphics controller 204 controls the LCD 103 used as a display monitor of the PC 100. The graphics controller 204 outputs a video signal corresponding to display data written to the VRAM 205 by the OS or the application programs to the LCD 103.

The south bridge 206 controls each device on a low pin count (LPC) bus and a peripheral component interconnect (PCI) bus. The south bridge 206 comprises the USB controller 207 for controlling the USB devices 208 and 209 and the ATA controller 210 for controlling the HDD 211 and the ODD 212. In the embodiment, the HDD 211 and the ODD 212 are described as eSATAp devices compatible with the eSATAp standard.

A PCI bus is provided between the north bridge 203 and the south bridge 206. The USB controller 207, the ATA controller 210, and the like may be connected to the PCI bus.

The USB controller 207 is connected individually to ports 215 and 216 of USB interfaces each through a signal line. The USB controller 207 performs data processing according to the USB standard between the CPU 201 and an external device connected via the port 215 or 216 to the PC 100.

The ATA controller 210 is connected individually to ports 217 and 218 of eSATAp interfaces each through a signal line. The ATA controller 210 performs data processing according to the eSATAp standard between the CPU 201 and an external device connected via the port 217 or 218 to the PC 100.

The HDD 211 is a storage device having a hard disk controller and a magnetic disk storage medium. The magnetic disk storage medium stores various types of software including the OS and various types of data. The ODD 212 drives storage media such as a digital versatile disk (DVD) that stores video content including DVD title, a compact disk (CD) that stores music data, and the like.

The EC/KBC 214 is connected to the south bridge 206. The EC/KBC 214 is a one-chip microcomputer comprising the integration of an embedded controller (EC) for power management and a keyboard controller (KBC) for controlling the keyboard 105 and the touchpad 106. The EC/KBC 214 is always powered on with power supplied from the power supply circuit 221 regardless of whether the PC 100 is powered on or off. The EC/KBC 214 turns on/off the PC 100 in cooperation with the power supply circuit 221 in response to user's operation on the power button 104.

The PSC 224 supplies necessary power to the power supply circuit 221 as well as terminating the power supply according to an instruction from the EC/KBC 214. The PSC 224 also determines, based on the system power tolerance, the total power capacity of external devices in use, and the power capacity of an external device connected to a port, whether power can be supplied to the port (the external device connected to the port). Thus, the PSC 224 supplies power to the port or does not provide the power supply.

Under the control of the EC/KBC 214 and the PSC 224, the power supply circuit 221 supplies a predetermined voltage (for example, 5 V) to a port (an external device connected to the port) using power supplied from the battery 222 in the main body unit 101 or power supplied via the AC adaptor 223 from an external power supply.

The power supply control circuit 225 comprises the PSC 224 and the device detection circuits 226 to 229. The number of the device detection circuits 226 to 229 (four, in the embodiment) is equal to the number of ports to which external devices are connected. The power supply control circuit 225 supplies power (for example, 5 V) to external devices each connected via a power supply line to one of the two USB interfaces (the ports 215 and 216) and the two eSATAp interfaces (the ports 217 and 218) while controlling power consumed by the ports (the external devices connected to the ports).

The device detection circuits 226 to 229 detect whether an external device is connected to the ports 215 to 218, respectively. Upon detecting an external device, the device detection circuits 226 to 229 each output a device detection signal to the PSC 224.

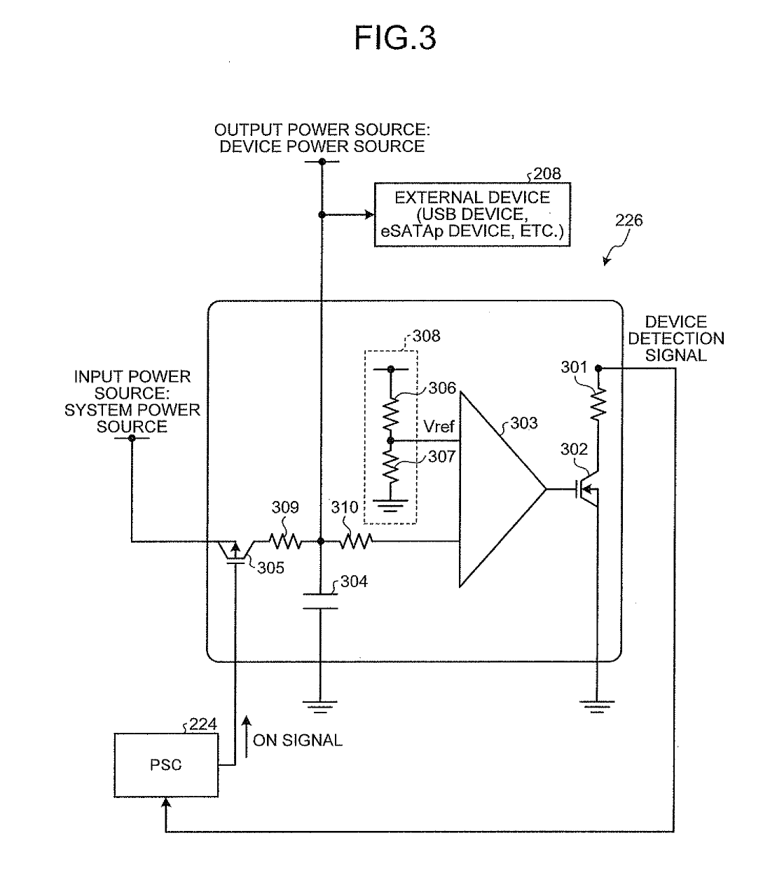

FIG. 3 illustrates an example of the device detection circuit for detecting an external device connected to each port of the PC 100. The PC 100 comprises, as integrated circuits (ICs), the same number of device detection circuits as the ports to which an external device is to be connected. FIG. 3 illustrates an example of a configuration of one of the device detection circuits 226 to 229, i.e., the device detection circuit 226.

With reference to FIG. 3, a description will be given of how the device detection circuit 226 detects an external device. As illustrated in FIG. 3, while an ON signal output from the PSC 224 is enabled, an external device such as the USB device 208 is connected to the port 215 of the USB interface, current is drawn. This turns on a field effect transistor (FET) switch 305, and voltage drops due to resistances 309 and 310. A comparator 303 compares a reference voltage Vref from a reference voltage generator 308 including a series-connected resistances 306 and 307 with an input voltage from a system power source that has dropped due to the resistances 306 and 307. The output end of the comparator 303 becomes “High” based on the comparison result. At this time, the FET switch 305 turns on, and a device detection signal becomes active (“Low”) and thereby is output to the PSC 224. With this, the PSC 224 detects that the USB device 208 is connected to the port 215 of the USB interface. A capacitor 304 is provided to absorb an abrupt change in voltage to stabilize the voltage. In the embodiment, an open drain output circuit is used for outputting the device detection signal. This enables a plurality of external devices connected to the ports to be connected to the same line.

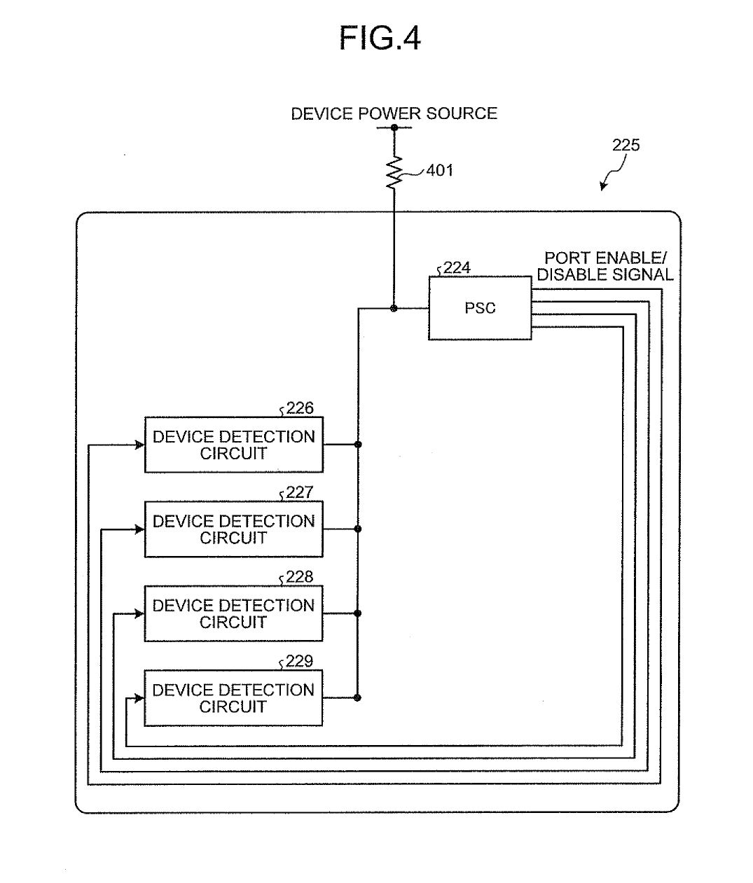

In the following, a description will be given of a determination on the amount of power used by external devices connected to the ports and power supply control for the ports with reference to FIGS. 3 and 4. FIG. 4 illustrates an example of the power supply control circuit 225 that determines the amount of power used by an external device connected to each of the ports 215 to 218 of the PC 100 and controls power supply to the ports 215 to 218.

In FIG. 4, the device detection circuits 226, 227, 228, and 229 correspond to the ports 215, 216, 217, and 218, respectively. With regard to the device detection circuit 226 and the port 215, one of FET switches 302 which is provided to the port 215 is ON when the connection of an external device is detected, i.e., when a device detection signal is output to the PSC 224. The same applies to the device detection circuits 227 to 229.

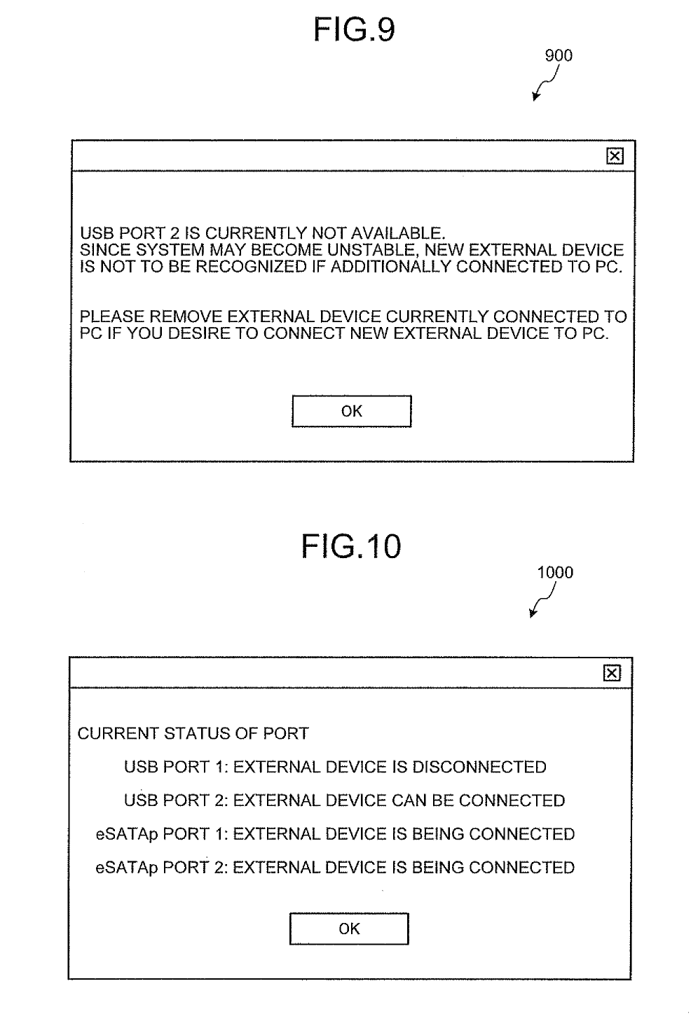

With the device detection circuits 226 to 229, the value of voltage division in the PSC 224 caused by resistance division varies according to the number (increase or decrease) of external devices connected to the PC 100. The PSC 224 always monitors the power margin between the voltage division value and a threshold determined based on the resistance value of resistances 301 in the device detection circuits 226 to 229 and the system power tolerance. If the power margin is lower than the amount of power (a voltage value: in the embodiment, a fixed value set depending on a computer product to which the external device is connected) used by an external device connected to a port, the PSC 224 outputs a port disable signal for an unused port to which the external device is connected to the unused port. Thus, the PSC 224 negates a power ON signal for the unused port, and the OS displays the event on the display monitor. In this case, even if an external device is newly connected to the PC 100, the OS does not recognize the external device. With reference to FIG. 9, a description will be given of an example of a screen 900 displayed on the display monitor at this time.

As illustrated in FIG. 9, the screen 900 displays a message indicating an unavailable port (in the example of FIG. 9, a USB port 2 is not available). In addition, since the system may become unstable due to the connection of an additional external device, a warning message is displayed that, if the additional external device is newly connected to the PC 100, the OS is not to recognize the additional external device. Further, a message is displayed to notify the user that an external device currently connected to the PC 100 needs to be removed (disabled) if the user wishes to connect the additional external device to the PC 100.

When the user disconnects the external device currently connected to the PC 100 from a port in response to the messages and thus the power margin becomes equal to or higher than the amount of power (a voltage value) used by an external device connected to a port, the PSC 224 outputs a port enable signal to only unused ports that consume power within the range of the power margin. Thus, the PSC 224 asserts a power ON signal for the unused ports. In this case, the PSC 224 notifies the OS that the state has changed, and the OS displays the event on the display monitor. With reference to FIG. 10, a description will be given of an example of a screen 1000 displayed on the display monitor at this time.

FIG. 10 is an example of the screen 1000 indicating the status of each port of the PC 100. This example assumes that an external device connected to a USB port 1 is disconnected therefrom. As illustrated in FIG. 10, the screen 1000 displays a message that the external device has been disconnected from the USB port 1, a message that an external device can be connected to the USB port 2, and a message that an external device is connected to an eSATAp port 1 and an eSATAp port 2.

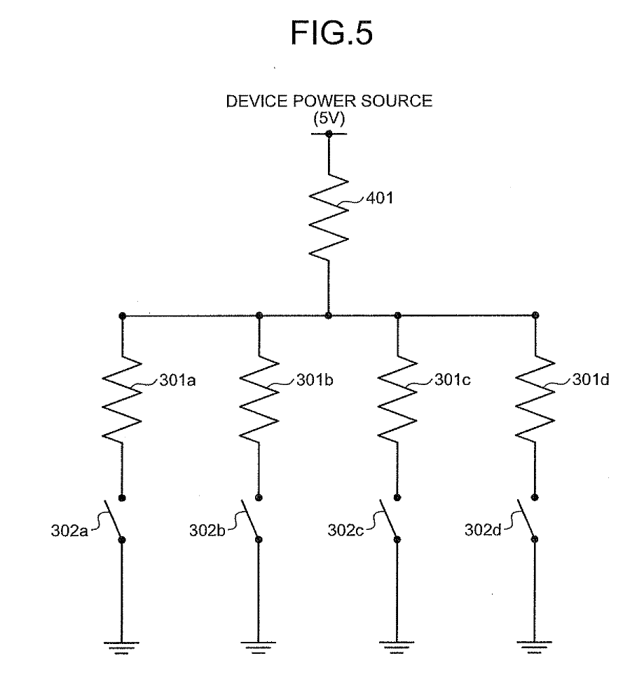

In the following, with reference to FIGS. 5 to 7, a description will be given of the specific operation of the circuits illustrated in FIGS. 3 and 4.

FIG. 5 illustrates an equivalent circuit of the output part of the device detection circuit illustrated in FIG. 4. In FIG. 5, resistances 301a to 301d correspond to the resistances 301 in the device detection circuits 226 to 229, respectively. Meanwhile, switches 302a to 302d correspond to the FET switches 302 in the device detection circuits 226 to 229, respectively. Besides, resistance 401 represents external pull-up resistance, and the value thereof is assumed to be 500Ω. In this circuit, when an external device is connected to a port, a corresponding switch turns on. Further, the system current tolerance in the system power tolerance is assumed to be 3 A.

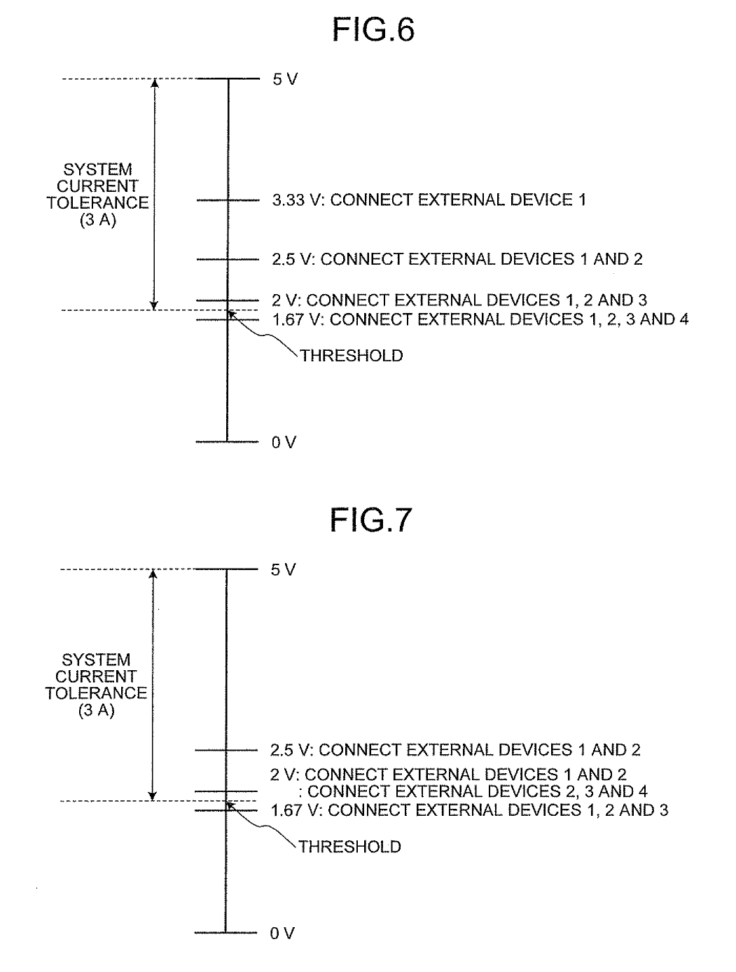

In the following, examples will be described in which four external devices are used. In the first example, all four ports to which the external devices are connected have a current capacity of 1 A (see table 1 and FIG. 6). In the second example, among the four ports, one port has a current capacity of 2 A, while the other three have a current capacity of 1 A (see table 2 and FIG. 7).

First, the first example will be described in which the maximum current and resistance of the external devices take values given in Table 1 below.

TABLE 1

| | Maximum Current | Resistance |
|---|---|---|
| External Device 1 | 1 A | 1 kΩ |
| External Device 2 | 1 A | 1 kΩ |
| External Device 3 | 1 A | 1 kΩ |
| External Device 4 | 1 A | 1 kΩ |

When an external device 1 is connected to a port, the switch 302a turns on, and the resistances 301a and 401 appear to be present between a device power source (for example, 5 V) and GND. With reference to FIG. 4, an intermediate potential of the resistances 301a and 401 is input to the PSC 224. That is, when the external device 1 is connected to a port, a voltage value input to the PSC 224 is 5×1000/(1000+500)=3.33 V.

When the external device 1 and also an external device 2 are each connected to a port, the switches 302a and 302b turn on, and an intermediate potential of the resistance 401 and the combined resistance (500Ω) of the resistances 301a and 301b becomes 2.5 V.

Similarly, when the external devices 1 and 2 and also an external device 3 are each connected to a port, the switches 302a, 302b, and 302c turn on, and an intermediate potential of the resistance 401 and the combined resistance (500/3Ω) of the resistances 301a, 301b, and 301c becomes 2 V. When the external devices 1, 2 and 3 and also an external device 4 are each connected to a port, the switches 302a, 302b, 302c, and 302d turn on, and an intermediate potential of the resistance 401 and the combined resistance (250Ω) of the resistances 301a, 301b, 301c, and 301d becomes 1.67 V.

FIG. 6 illustrates an example of the relationship between a threshold of voltage based on the system current tolerance and an intermediate potential input to the PSC 224 when at least one external device is connected to a port.

It is assumed herein that the above threshold is set between 1.67 V and 2 V when the system current tolerance is 3 A. When receiving a potential equal to or lower than the threshold, the PSC 224 turns off the power of unused ports. Accordingly, if all the ports have a current capacity of 1 A, external devices can be connected to up to three ports.

Next, the second example will be described in which the maximum current and resistance of the external devices take values given in Table 2 below.

TABLE 2

| | Maximum Current | Resistance | |
|---|---|---|---|
| External Device 1 | 2 A | 500 | Ω |
| External Device 2 | 1 A | 1 | kΩ |
| External Device 3 | 1 A | 1 | kΩ |
| External Device 4 | 1 A | 1 | kΩ |

In the second example, the external device 1 may consume more power than in the first example.

The voltage division value can be calculated in the same manner as described previously in the first example. That is, when the external device 1 is connected to a port, a voltage value input to the PSC 224 is 2.5 V. Similarly, when the external devices 1 and 2 are each connected to a port, a voltage value of 2 V is input to the PSC 224. When the external devices 2, 3 and 4 are each connected to a port, a voltage value of 2 V is input to the PSC 224. Besides, when the external devices 1, 2 and 3 are each connected to a port, a voltage value of 1.67 V is input to the PSC 224.

FIG. 7 illustrates another example of the relationship between a threshold of voltage based on the system current tolerance and an intermediate potential input to the PSC 224 when at least one external device is connected to a port.

It is assumed herein that the above threshold is set between 1.67 V and 2 V when the system current tolerance is 3 A. Accordingly, if a port having a current capacity of 2 A is used, external devices can be connected to up to two ports including the one having a current capacity of 2 A. On the other hand, if the port having a current capacity of 2 A is not used, external devices can be connected to up to three ports each having a current capacity of 1 A.

The resistance value of resistances 401a to 401d, the system power tolerance, and the like may vary according to the specification of the PC 100.

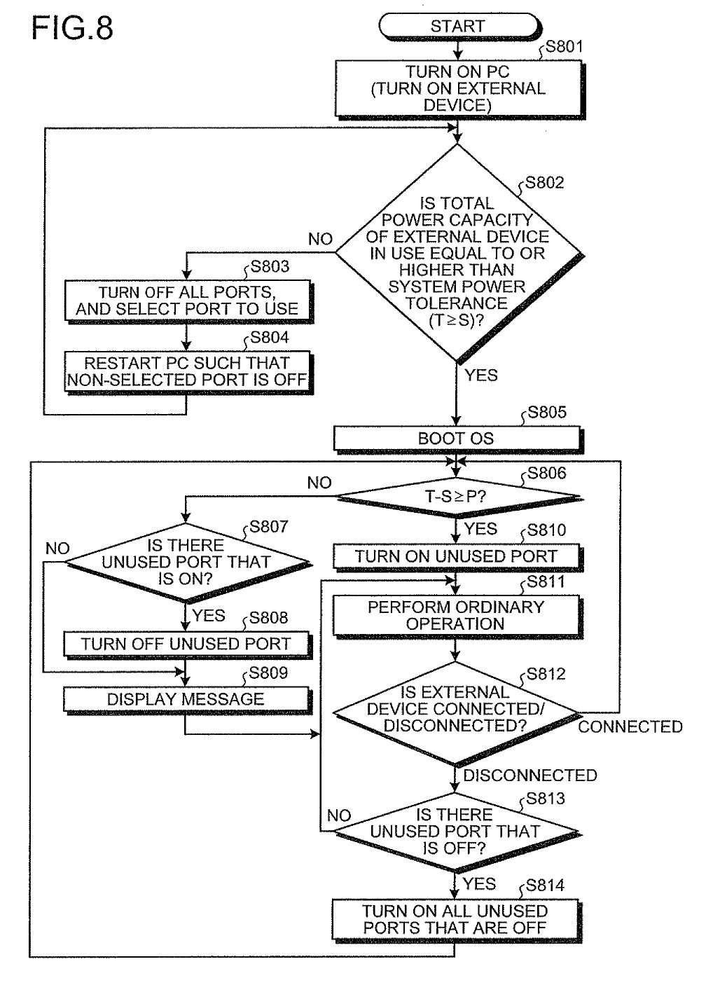

With reference to FIG. 8, a description will be given of an example of the operation of the PC 100 related to power supply control according to the embodiment. It is assumed in this example that all external devices cannot be connected to the PC 100 because of the system power of the PC 100 and that PC 100 lacks power corresponding to one port for connection of an external device.

When the PC 100 turns on, an external device connected via a port to the PC 100, if any, also turns on (S801). At this time, the CPU 201 executes the BIOS 230.

If at least one external device is connected via at least one port to the PC 100, the PSC 224 determines whether the total power capacity of the external device in use (hereinafter, indicated by “S”) is equal to or lower than the system power tolerance (hereinafter, indicated by “T”) (S802). That is, the PSC 224 determines whether T≧S.

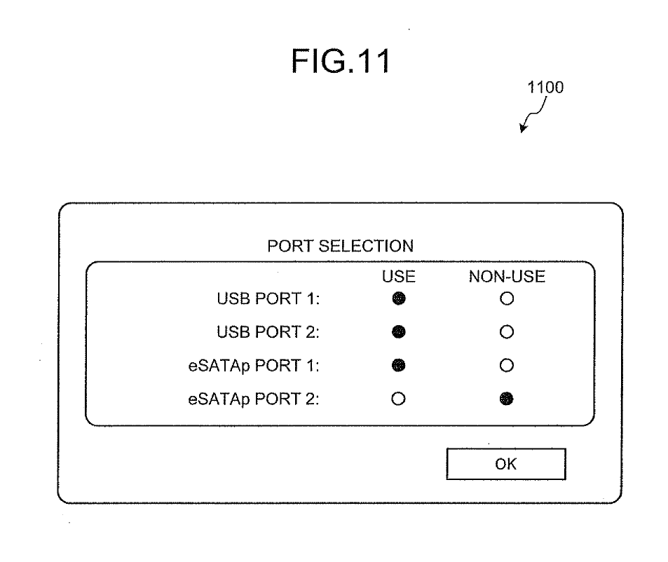

If the PSC 224 determines that T<S (No at S802), the BIOS 230 terminates power supply to all the ports of the PC 100, and displays a screen 1100 on the display monitor to allow the user to select a port (an external device) to use (S803). FIG. 11 illustrates an example of the screen 1100. As illustrated in FIG. 11, when each port is selected to be used or not to be used and an “OK” button is pressed, the USB ports 1 and 2, and the eSATAp port 1 are set to be used, while the eSATAp port 2 is set to be not used.

Thereafter, the PC 100 is restarted such that the selected ports are powered on and the non-selected port is powered off (S804), and the CPU 201 executes the BIOS 230. In the example of FIG. 11, the USB ports 1 and 2, and the eSATAp port 1 are turned on, while the eSATAp port 2 is turned off. Then, the process at S802 is repeated again.

On the other hand, if the PSC 224 determines that T≧S (Yes at S802), the BIOS 230 boots the OS (S805).

The PSC 224 then determines whether the difference (T−S) between the system power tolerance (S) and the total power capacity of the external devices in use (T) is equal to or larger than the power capacity of one external device to be connected via a port to the PC 100 (hereinafter, indicated by “P”), i.e., T−S≧P (S806).

If the PSC 224 determines that T-S<P (No at S806), it means that there is no power margin to accept the one external device to be connected. In this case, the PSC 224 determines whether there is an unused port that is powered on (S807). This is checked because the unused port may have already been turned off at 5803.

If there is an unused port that is powered on (Yes at S807), the PSC 224 turns off the unused port (S808). With this, the unused port cannot be used and, even if an external device is additionally connected to the unused port, the external device is not recognized.

If there is no unused port that is powered on (No at S807), or after the process at S808, the OS displays the screen 900 with messages as illustrated in FIG. 9 on the display monitor to notify the user that the unused port is not available (S809). Then, the process moves to S810. Alternatively, a setting screen (not illustrated) that allows the user to forcibly use the port may be displayed instead of the screen 900. This is because, for example, when the specification is set based on the above threshold, power supply may be disabled for an external device newly connected to the PC 100. This results in that the user cannot use even a device (for example, a mouse) that is supposed to have a current capacity less than the threshold, which is inconvenient. Therefore, the user may be allowed to forcibly turn on a port that the user desires to use through such a setting screen regardless of the threshold.

On the other hand, if determining that T-SP (Yes at S806), the PSC 224 turns on all unused ports that are powered off (S810). In this case, if an external device is connected to an unused port that is powered on, the external device is supplied with power and thereby becomes operable (available). This means only that the unused port can accept an external device, and an external device need not necessarily be connected to the unused port at this point.

After S809 or S810, power is supplied to a port, among the ports, to which an external device is connected, and the port enters ordinary operation mode (S811).

In the ordinary operation mode, an external device may be disconnected from the port or newly connected to the port (S812). When an external device is connected to an unused port that is powered on (Connected at S812), the process returns to S806, and the process described above is performed.

On the other hand, when an external device is disconnected from an unused port that is powered on (Disconnected at S812), the PSC 224 determines whether there is an unused port that is powered off (S813). The user may connect an external device to an unused port that is powered off at S812. In this case, however, the external device is not recognized, and therefore the process does not return to S806.

Subsequently, the PSC 224 turns on all unused ports that are powered off (S814). Then, the process returns to S806, and the process described above is performed.

While, in the embodiment, all unused ports that are powered off are turned on at S810 and S814, the process at S810 and S814 may be skipped, and the process of turning on all unused ports that are powered off may be added immediately before S806.

As described above, according to the embodiment, it is possible to control ports to connect external devices to an information processing apparatus depending on power that can be supplied from the information processing apparatus. Thus, an increase in power capacity can be suppressed, which prevents an increase in cost and AC adaptor capacity and also upsizing of the information processing apparatus.

Moreover, according to the embodiment, external devices to be supplied with power from the information processing apparatus are restricted according to the current capacity. Thus, it is possible to prevent the information processing apparatus from being hung up or from shutting down when power required by a plurality of external devices exceeds the power supply capacity of the information processing apparatus.

Furthermore, according to the embodiment, when it is detected that external devices are connected to the information processing apparatus, ports for use are reserved in the order in which the external devices are connected, and the power of the information processing apparatus is expected to exceed a threshold, an external device that is to be connected thereafter is not recognized and is not turned on. Therefore, even if an eSATAp device or a USB device is connected to the information processing apparatus while an external device previously connected is in operation, power supply can be prevented from running short, which prevents data loss and the like.

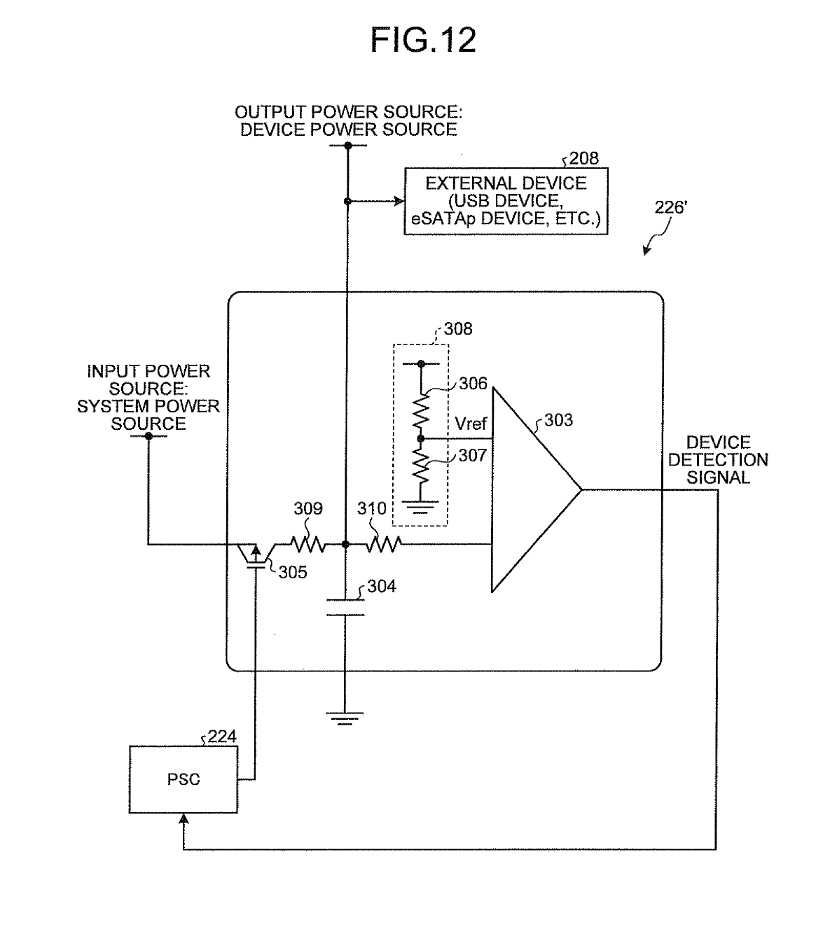

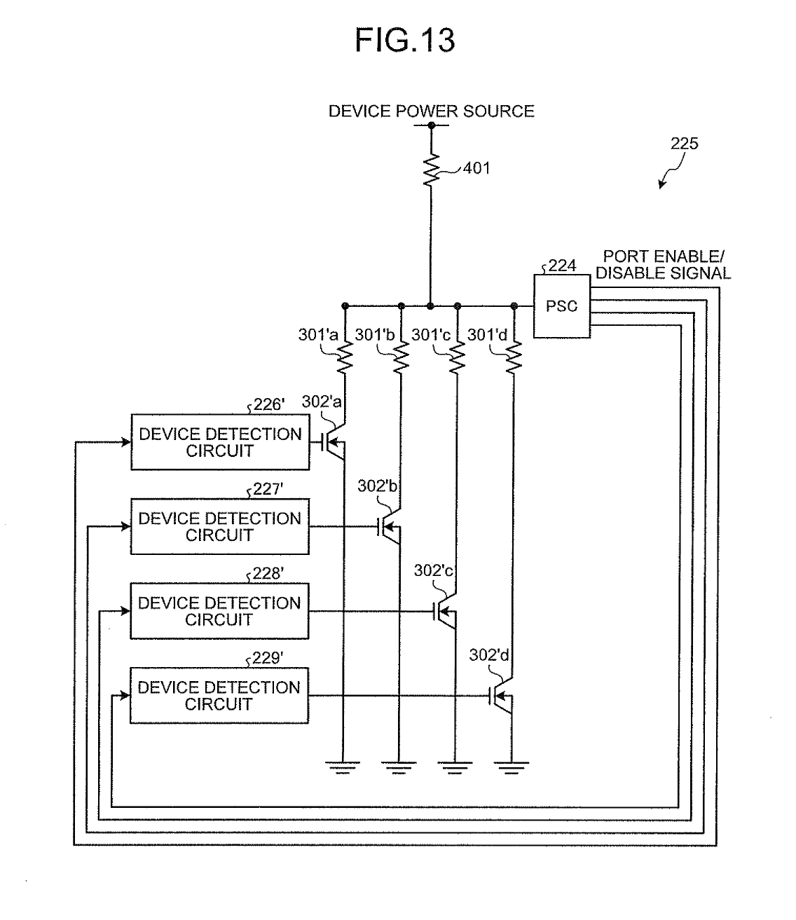

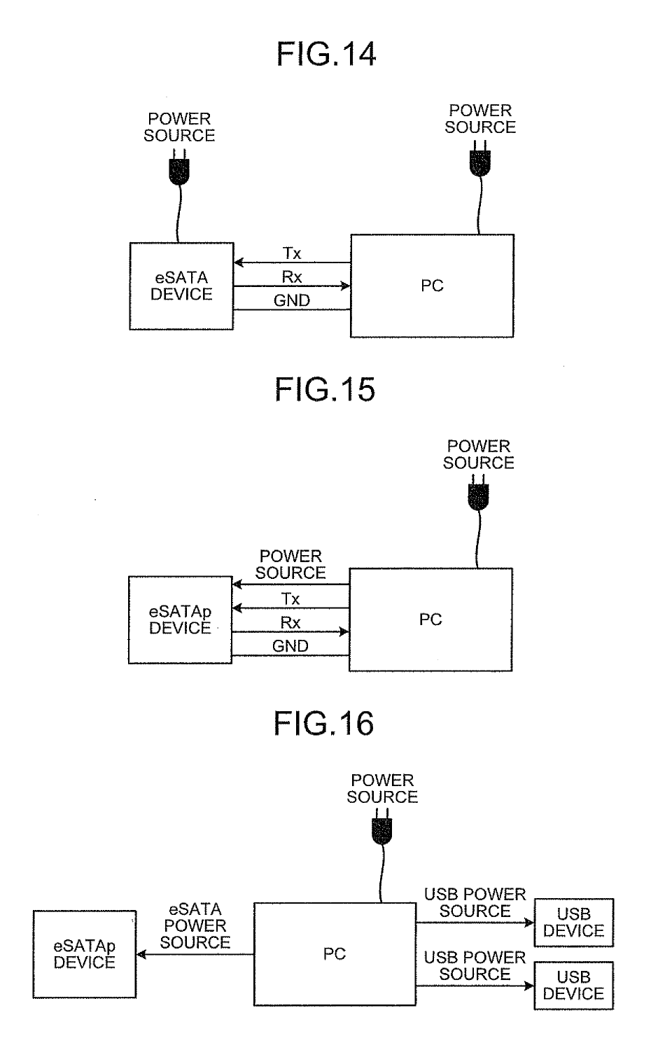

While, in the embodiment described above, the resistances 301 and the FET switches 302 are described as being included in the device detection circuits 226 to 229 as illustrated in FIG. 3, they may be provided outside the device detection circuits 226 to 229. FIGS. 12 and 13 illustrate resistances 301′a to 301′d and FET switches 302′a to 302′d, which are provided outside of device detection circuits 226′ to 229′, corresponding to those illustrated in FIGS. 3 and 5.

In this case also, device detection and power supply control are performed in the same manner as described previously in the above embodiment. However, because the resistances 301′a to 301′d are removed from the ICs of the device detection circuits 226′ to 229′, the user can set the resistance value of the resistances 301′a to 301′d. This increase the design freedom of the entire power supply control circuit.

While a specific embodiment is described above, the embodiment is not so limited and is susceptible to variations and modifications. For example, if an external device can be detected by the BIOS and the OS, and power off control for each port is performed in real time based on the detection of an external device, the embodiment can be implemented without hardware.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a plurality of interface ports configured to be supplied with power from the information processing apparatus and connected to a plurality of external devices;
a device detector configured to detect whether one of the external devices is connected to one of the interface ports; and
a power supply controller configured to control whether to supply power to the one of the external devices connected to the one of the interface ports detected by the device detector based on power tolerance of the information processing apparatus, a total amount of power of external devices in use, and a power capacity of the one of the external devices.

2. The information processing apparatus of claim 1, wherein
the device detector comprises a reference voltage generator and a comparator,
the comparator is configured to compare a reference voltage generated by the reference voltage generator with a dropped input voltage when the one of the external devices is connected to the one of the interface ports, and
the device detector is configured to detect whether the one of the external devices is connected to the one of the interface ports based on the comparison result.

3. The information processing apparatus of claim 1, wherein
the power supply controller comprises a power source controller configured to transmit a signal comprising a command of enabling the one of the interface ports to the one of the external devices detected to be connected, and
the power supply controller is configured to supply power to the one of the interface ports with the signal.

4. The information processing apparatus of claim 3, wherein the power source controller is configured to transmit the signal to the one of the interface ports when a difference between the power tolerance of the information processing apparatus and the total amount of power of external devices in use is equal to or larger than the power capacity of the one of the external devices connected to the one of the interface ports.

5. The information processing apparatus of claim 1, wherein the interface ports comprise a universal serial bus (USB) interface port.

6. The information processing apparatus of claim 1, wherein the interface ports comprise an external serial advanced technology attachment power (eSATAp) interface port.

7. A power supply control method applied to an information processing apparatus comprising a plurality of interface ports configured to be connected to a plurality of external devices, a device detector, and a power supply controller for the interface ports from the information processing apparatus, the power supply control method comprising:
detecting whether one of the external devices is connected to one of the interface ports; and
controlling whether to supply power to the one of the external devices connected to the one of the interface ports detected by the device detector based on power tolerance of the information processing apparatus, a total amount of power of external devices in use, and a power capacity of the one of the external devices.

8. The power supply control method of claim 7, wherein
the device detector comprises a reference voltage generator and a comparator, and
the detecting comprises the comparator comparing a reference voltage generated by the reference voltage generator with a dropped input voltage when the one of the external devices is connected to the one of the interface ports to detect whether the one of the external devices is connected to the one of the interface ports based on the comparison result.

9. The power supply control method of claim 7, further comprising:
transmitting a signal comprising a command of enabling the one of the interface ports to one of the external devices detected to be connected, and
supplying power to the one of the interface ports.

10. The power supply control method of claim 9, further comprising:
transmitting the signal to the one of the interface ports when a difference between the power tolerance of the information processing apparatus and the total amount of power of external devices in use is equal to or larger than the power capacity of the one of the external devices connected to the one of the interface ports.

11. The power supply control method of claim 7, wherein the interface ports comprise a universal serial bus (USB) interface port.

12. The power supply control method of claim 7, wherein the interface ports comprise an external serial advanced technology attachment power (eSATAp) interface port.
